(19) United States
(12) Patent Application Publication
(10) Pub. No.: US 2026/0054300 A1
(43) Pub. Date: Feb. 26, 2026

(54) System and Method for Removing Contaminated Materials from Railcars for Subsequent Recycling of the Rail Cars

(71) Applicant: Stephen J. King, Tunkhannock, PA (US)

(72) Inventor: Stephen J. King, Tunkhannock, PA (US)

(21) Appl. No.: 19/234,332

(22) Filed: Jun. 11, 2025

Related U.S. Application Data
(60) Provisional application No. 63/685,642, filed on Aug. 21, 2024.

(51) Int. Cl. B09B 3/30; B01D 46/00; B01D 46/58; B08B 7/02; B09B 101/05; B09B 101/35; B24C 1/00; B61K 13/00

(52) U.S. Cl. CPC B09B 3/30; B01D 46/0041; B01D 46/58; B08B 7/02; B24C 1/003; B01D 2279/51; B09B 2101/05; B09B 2101/35; B61K 13/00

(57) ABSTRACT

Systems, methods, and other embodiments for removing contaminated materials such as asbestos from railcars (i.e., train cars and subway cars) for subsequent recycling of the railcars. In particular, a collapsible inner containment structure having a HEPA negative air pressure is used. A door on the inner containment structure is opened at one end of the inner containment structure and a railcar is transported into a work area located within the inner containment structure. The door is then closed so that the inner containment structure can maintain the negative pressure within the inner containment structure. The contaminated materials such as asbestos are removed from the inside of the railcar using a mixture of pressurized water and media.

### CROSS-REFERENCE TO RELATED APPLICATION

This application claims benefit of U.S. Patent Application Ser. No. 63/685,642, filed on Aug. 21, 2024, the disclosure of which is hereby incorporated by reference in its entirety to provide continuity of disclosure to the extent such a disclosure is not inconsistent with the disclosure herein.

### FIELD OF THE INVENTION

The present invention relates to a system and method for removing contaminated materials such as asbestos from railcars (i.e., train cars and subway cars) for subsequent recycling of the railcars. In particular, a collapsible inner containment structure having a HEPA negative air pressure is used. A door on the inner containment structure is opened at one end of the inner containment structure and a railcar is transported into a work area located within the inner containment structure. The door is then closed so that the inner containment structure can maintain the negative pressure within the inner containment structure. The contaminated materials such as asbestos are removed from the inside of the railcar using a mixture of pressurized water and media. The inside of the railcar is inspected to determine if all of the asbestos has been removed from the inside of the railcar. A final wash of the railcar is completed. Finally, the door is opened and the cleaned railcar is sent off for subsequent recycling.

### BACKGROUND OF THE INVENTION

It is known that there is a need to recycle large objects such as railcars (i.e., train cars and subway cars). Most of the railcars are constructed of metal that can be recycled; however, some railcars include sprayed-on interior coatings such as asbestos coatings which were added for sound deadening, fire proofing, insulation, and the like. However, the removal of asbestos is highly regulated. In many cases, it costs more to remove the asbestos than what can be earned by recycling the railcars. Therefore, it was previously not cost-effective to recycle the portions of the railcars that included interior asbestos coatings.

It is also known that the wheels and trucks of the railcars can be removed and recycled. However, the portions of the railcars that have asbestos were not recycled. This resulted in only about 65% of the railcars being recycled. This created a landfill problem since the railcars that were not recycled were typically just sent to a landfill which created hazardous waste containment issues at the landfill. Furthermore, the landfill to which the asbestos is being sent has to be an EPA approved landfill that can accept asbestos. These contaminated railcars also present a problem in that the transportation of the contaminated railcars with other waste metal materials may create metal cross contamination with asbestos which can also take up more space in the landfill and result in the lose of the other waste metal material forever to the landfill.

It is further known that pressurized water has been used to blast the asbestos coatings in order to remove the coatings from the inside of the railcar. However, in the known systems and methods for removing coatings, large amounts of wastewater were produced and these large amounts of wastewater were costly to dispose of properly.

It is also known that there are sand blasting methods which can be used to remove the asbestos from the railcar. However, these known sand blazing methods can cause a large amount of the asbestos to become airborne. Furthermore, these known sand blasting methods are dangerous for the workers and difficult to get approved by the environmental regulation authorities. Clearly, there is a need for an efficient method of removing contaminated materials such as asbestos from large objects like a railcar so that a greater percentage of the railcar can be recycled.

This invention's purpose is to fulfill these and other needs in the art of removing contaminated materials such as asbestos from railcars such as train cars and subway cars for subsequent recycling of the railcars in a manner more apparent to the skilled artisan once given the following disclosure.

The preferred system and method for removing contaminated materials such as asbestos from railcars such as train cars and subway cars for subsequent recycling of the railcars, according to various embodiments of the present invention, offers the following advantages: ease of use; portability; reduced recycling costs; improved recycling efficiency; reduced airborne emissions; increased worker safety; decreased landfill usage; improved ability to remove asbestos quickly; and reduced wastewater creation. In many of the preferred embodiments, these advantages are optimized to the extent that is considerably higher than previously achieved in prior known systems and methods for removing contaminated materials such as asbestos from railcars such as train cars and subway cars for subsequent recycling of the railcars.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a schematic illustration of an outer containment enclosure, according to various embodiments of the present invention described herein.

FIG. 2 is a schematic illustration of an inner containment enclosure having a door, according to various embodiments of the present invention described herein.

FIG. 3 is a schematic illustration of a forklift that is capable of transporting the railcar into and out of the inner containment enclosure, according to various embodiments of the present invention described herein.

FIG. 4 is another schematic illustration of the inner containment enclosure having a door with a railcar being located within the inner containment enclosure, according to various embodiments of the present invention described herein.

FIG. 5 is a schematic illustration of a decontamination section of the inner containment enclosure, according to various embodiments of the present invention described herein.

FIG. 6 is a schematic front view of a HEPA filtration assembly of the inner containment enclosure, according to various embodiments of the present invention described herein.

FIG. 7 is a schematic rear view of the HEPA filtration assembly of the inner containment enclosure, according to various embodiments of the present invention described herein.

### DETAILED DESCRIPTION OF THE INVENTION

The terminology used herein is to describe particular embodiments only and is not intended to be limiting to the invention. As used herein, the term “and/or” includes any and all combinations of one or more of the associated listed items. As used herein, singular forms “a”, “an”, and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new system and method for removing contaminated materials such as asbestos from railcars (i.e., train cars and subway cars) for subsequent recycling of the railcars is discussed herein. In the following description, for purposes of explanation, numerous specific details are set forth to provide a thorough understanding of the present invention. It will be evident, however, to one skilled in the art that the present invention may be practiced without these specific details.

The present disclosure is considered an exemplification of the invention and is not intended to limit the invention to the specific embodiments illustrated by the figures or description below.

It is known that typically, asbestos becomes airborne when being removed from surfaces. The airborne particles have a spike-shaped form. When inhaled, the asbestos particles lodge in the alveoli of the lungs, thereby causing constant irritation which may later result in lung cancer. Therefore, the removal of asbestos and substances containing asbestos are highly regulated at the local, state and federal levels. Consequently, since removal of asbestos is strictly regulated, gaining government approval is time-consuming and difficult.

Furthermore, the regulatory agencies are toughest on regulating the processes that involve a large amount of airborne asbestos. They are less stringent on other processes that trap the asbestos in liquids. However, there are stringent requirements on how to dispose of these asbestos-containing liquids. Sometimes it is less costly to pay for another entity to dispose of these liquids than to get approval, set up equipment, operate, and monitor a facility that disposes of asbestos-contaminated liquids.

As mentioned earlier, sand blasting can cause a large amount of asbestos particles to become airborne. Furthermore, sand blasting can also result in a large amount of contaminated sand to remediate or remove and dispose of.

It is known that the water from water blasting collects airborne asbestos particles and results in fewer asbestos particles becoming airborne. However, water blasting is not as effective on removing the coatings on coated metal surfaces as other removal methods such as sand blasting. Furthermore, water blasting also results in a large amount of contaminated liquid to remediate or dispose of. Finally, it may cost more to run the process than the amount received for the recycled metal if another entity has to be paid to dispose of (or remediate) the contaminated liquid. Therefore, prior art water blasting processes are not cost effective. Furthermore, the water can be filtered with 5 micron filters to “clean” the water legally and dispose into a sanitary sewer. However, the problem with this process is that samples of the “clean” water have been collected and it has been determined that with this process the asbestos is not removed but instead the asbestos is now rendered to below 5 microns. Since the present invention uses much less water, it has been determined that in the present invention it is better just to settle, filter the water, and recycle the water and then reuse the water through the water and media blasting machine of the present invention.

Finally, it is known that utilizing water blasting with sand is efficient, but results in a large amount of water and sand to remove. This method creates the same problems with the contaminated water and sand, as discussed above. Therefore, this process is also is not cost-effective.

Conversely, the present invention employs compressed air, a biosoluable abrasive, and water blasting. The abrasive increases the asbestos removal efficiency and reduces the amount of water required (and the amount of water to be disposed of or recycled). Furthermore, while the abrasive does not necessarily dissolve in the water, it is rendered smaller and is not a toxic or hazardous material. Also, in the present invention, the spent abrasive is disposed of with the asbestos. The water and media blasting machine of the present invention uses higher compressed air pressures which makes the amount of abrasive and water needed to be much less and more manageable. Also, the compressed air adds to the asbestos removal efficiency. However, there is still some asbestos particles that are released into the air. In order to address this issue, the workers have full body suits with a filtered breathing apparatus that are designed to repel particles of the size of asbestos particles. Also, the asbestos removal process is conducted within a negative pressure containment area located within an inner containment enclosure that is also equipped with a HEPA filtration assembly in order to filter out any of the airborne asbestos particles that are released into the air within the inner containment enclosure.

A unique aspect of the present invention is that the entire process is performed in an air-tight inner containment structure that is large enough to allow a railcar to be located within the inner containment structure. Furthermore, the negative pressure is created at one side of the inner containment structure which causes a one-way flow of the air through the inner containment structure and out through HEPA filters on the other side of the inner containment structure. In this manner, the airborne asbestos particles that are released into the air within the inner containment enclosure are captured in the HEPA filters. When the HEPA filters are changed, they are properly disposed as is required by law for asbestos.

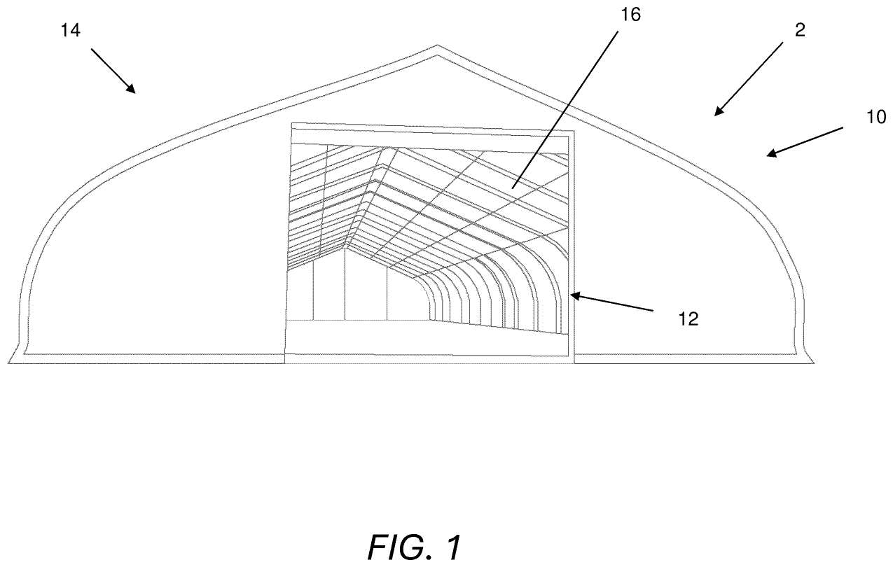

The present invention will now be described by referencing the appended figures representing preferred embodiments. FIGS. 1-7 are illustrations of a system for removing contaminated materials such as asbestos from railcars such (i.e., train cars and subway cars) for subsequent recycling of the railcars.

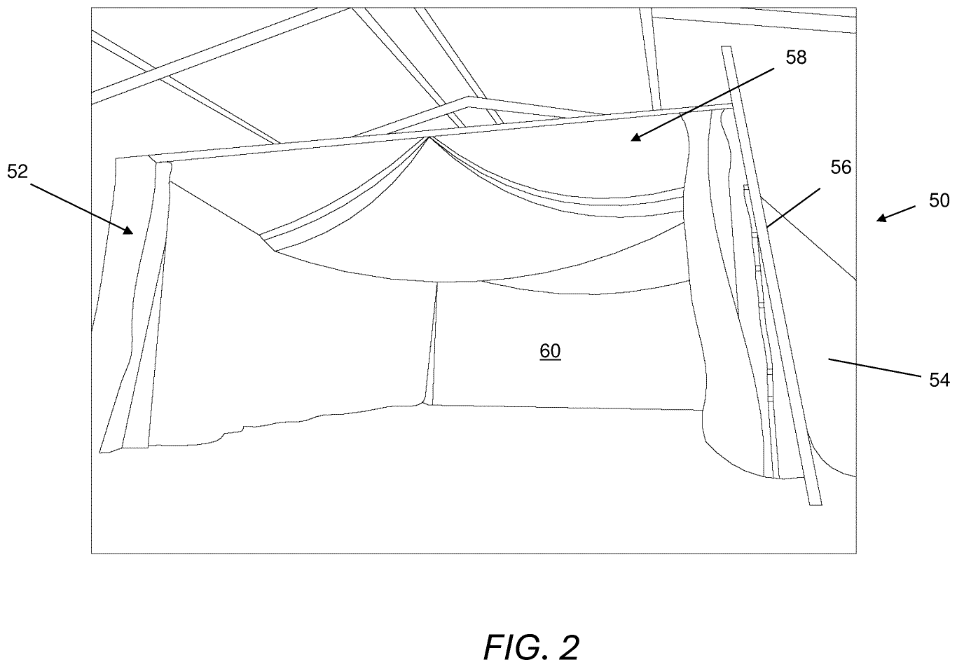

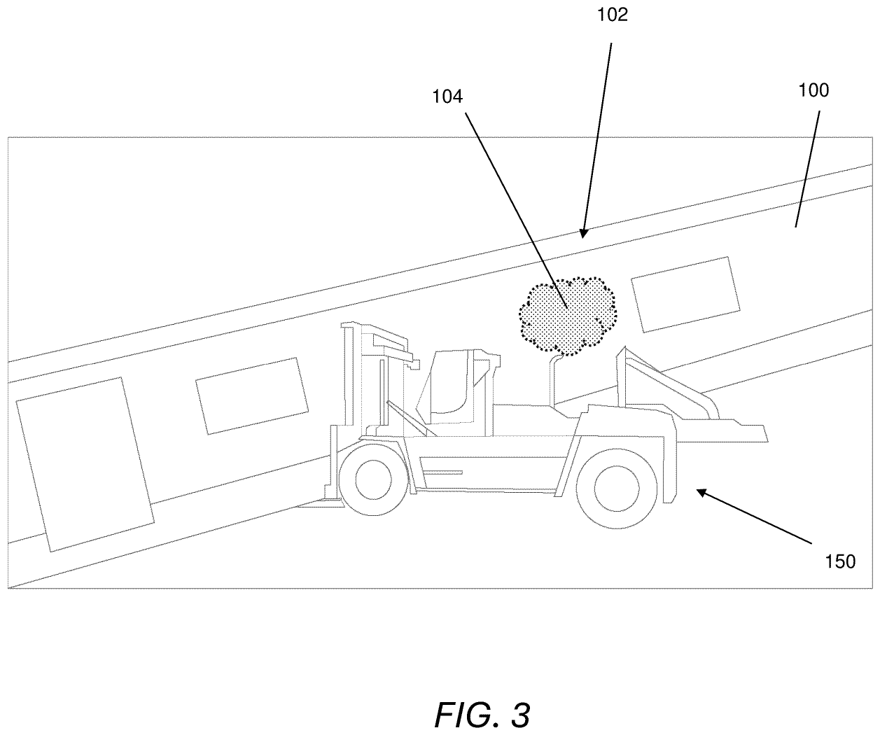

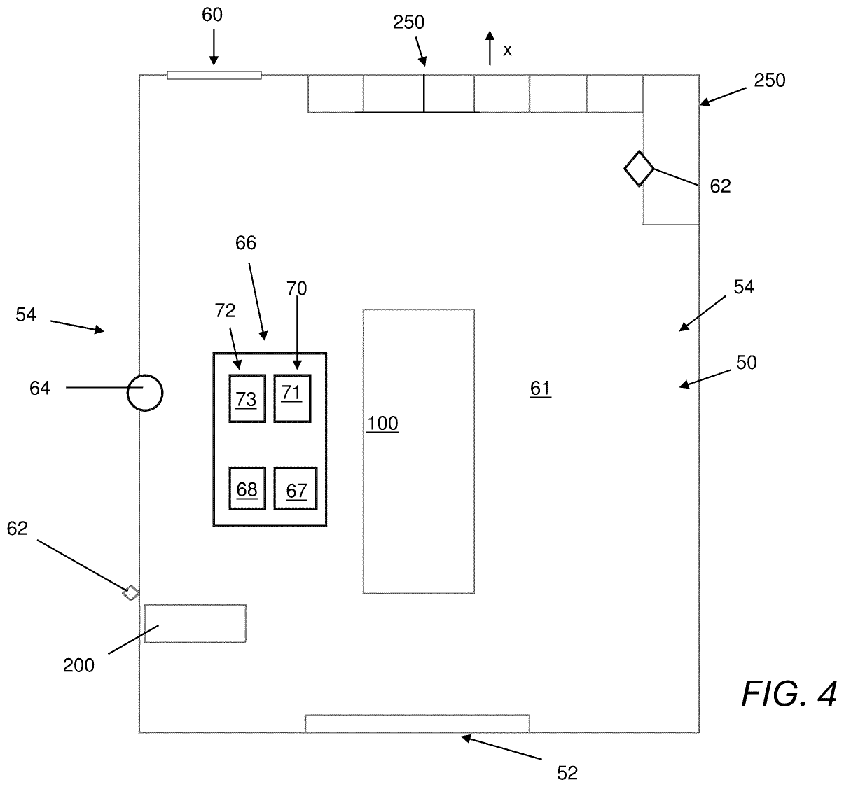

In particular, as shown in FIGS. 1-7, there is illustrated a system 2 for removing contaminated materials such as asbestos from railcars (i.e., train cars and subway cars) for subsequent recycling of the railcars. System 2 includes, in part, an outer containment structure 10 having an opening 12, covering 14, a frame 16, and inner containment structure 50 (FIGS. 2 and 4). Preferably, in one embodiment, outer containment structure 10 is constructed of any suitable, durable material that will adequately enclose inner containment structure 50 and provide the necessary protection for inner containment structure 50 from rain, snow, sun, sleet, hail, and/or wind. For example, as shown in FIG. 1, outer containment structure 10 is constructed with a covering 14 placed over a frame 16. Furthermore, an opening 12 that is sized and shaped so that inner containment structure 50 and railcar 100 (FIGS. 3 and 4) can be easily and safely located within the outer containment structure 10.

With respect to FIG. 2, there is illustrated an example of an inner containment structure 50. Preferably, in one embodiment, inner containment structure 50 includes, in part, front, roll-up door 52, outer walls 54, frame 56, roof 58 and rear door 60. It is to be understood that while inner containment structure 50 is shown as a type of tent structure, inner containment structure 50 can also be constructed in the form of a more rigid structure made of metallic or other similar rigid materials. An important aspect of inner containment structure 50 being that it is constructed so that a negative pressure (vacuum) of around −0.01-03″/H₂O water column can be created within the interior of the inner containment structure 50, as will be discussed in greater detail later. It is also to be understood that rear door 60 is shown as being in an open position in FIG. 2. Typically, rear door 60 is pulled shut to create a closed-in area so that the negative pressure within the inner containment structure 50 can be created.

A unique aspect of the present invention is the collapsible air lock construction of the inner containment structure 50. In particular, the collapsible “airlock” is only used to bring the railcar 100 (FIG. 3) into and out of the containment work area 61 (FIG. 4) in order to not cross contaminate outside air when the front, roll up door 52 is open to outside. The use of the collapsibility of the airlock is for space savings inside the outer containment structure 10 since one only needs the airlock when opening the inner containment structure 50 and bringing the railcar 100 into the inner containment structure 50 and removing the railcar 100 from the inner containment structure 50. The collapsible nature of the inner containment structure 50 allows the inner containment structure 50 to be taken down, transported to another location that has a similar outer containment structure 10, constructed within that other similar outer containment structure 10, equipped with the necessary equipment needed to preform the asbestos removal, and used to remove the asbestos from other railcars 100 without having to construct separate systems 2 for removing contaminated materials such as asbestos from railcars (i.e., train cars and subway cars) for subsequent recycling of the railcars.

With respect to FIG. 3, there is illustrated a conventional forklift 150 that is capable of transporting the railcar 100 into and out of the inner containment enclosure 50, as will be discussed in greater detail later. As further shown in FIG. 3, railcar 100 has wheels and trucks (not shown) conventionally removed from the railcar 100 prior to the railcar 100 being transported into the inner containment enclosure 50. Finally, as shown in FIG. 3, the railcar 100 includes an interior coating 102 wherein the interior coating includes asbestos particles 104. It is to be understood that only a portion of the interior coating 102 is shown. In reality, a large portion of the interior of the railcar 100 is covered with the coating 102.

### Inner Containment Enclosure 50

As shown in FIG. 4, in one embodiment, after the inner containment enclosure 50 has been constructed the inner containment enclosure 50 can be equipped with the equipment necessary to remove the asbestos from the railcar 100. In particular, the inner containment enclosure 50 can be equipped with, in part, inner roll-up door 52, outer walls 54, rear door 60, asbestos removal containment area 61, railcar 100, decontamination enclosure 200, ground fault interrupters (GFIs) 62, sump pump 64, media/water delivery assembly 66, and HEPA filter assembly 250. As discussed earlier, inner, roll-up door 52 provides an entrance opening for the railcar 100 to enter into and exit from the inner containment enclosure 50. Preferably, in one embodiment, inner, roll-up door 52 should be constructed to that it is capable of opening and closing and also allow the HEPA filter assembly 250 to create a vacuum within the interior of the inner containment enclosure 50, as will be discussed in greater detail later.

With respect to asbestos removal containment area 61, the railcar 100 is located within the inner containment enclosure 50 over the asbestos removal containment area 61. In this area 61, the railcar 100 will be subjected to the pressurized mixture of water and media so that any coating 102 contaminated materials 104 such as asbestos will be efficiently removed from the inside of the railcar 100.

With respect to media/water delivery assembly 66, in one embodiment, media/water delivery assembly 66 includes, in part, compressor 67, media supply 68, water supply 72, and media and water mixing/spraying assembly 70. In particular, compressor 67 should be configured to be able to provide the desired air pressure for the media and water mixing/spraying assembly 70. Media supply 68 should be configured to be able to retain a desired amount of media 71 and deliver the media 71 to the media and water mixing/spraying assembly 70. Water supply 72 should be configured to be able to retain a desired amount of water 73 and deliver the water 73 to the media and water mixing/spraying assembly 70. Media and water mixing/spraying assembly 70 should be configured to be able to properly mix a desired amount of water 73 and media 71 and interact with compressor 67 in order to spray or otherwise deliver the desired mixture of water and media onto the surface of the railcar 100 in order to adequately remove the coating 102 containing the asbestos particles 104.

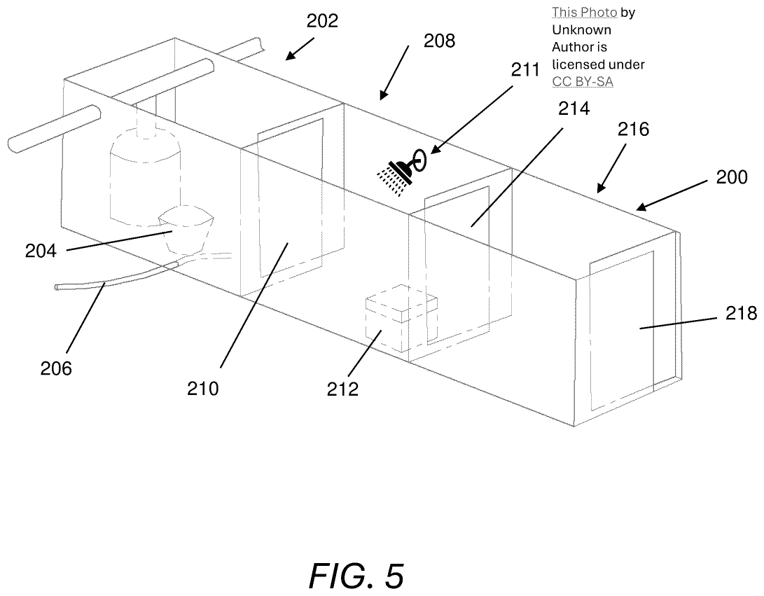

With respect to decontamination enclosure 200, as shown in FIG. 5, in one embodiment, decontamination enclosure 200 includes, in part, asbestos removal area 202, dirty change area 208, and clean change area 216. It is to be understood that decontamination enclosure 200 is to be utilized by the personnel who are assisting in the removal of the contaminated materials 104 such as asbestos from the railcar 100. Regarding asbestos removal area 202, in one embodiment, asbestos removal area 202 includes a conventional waste bin 204. Waste bin 204 can be used as a receptacle for collecting and disposing of larger pieces of contaminated materials such as asbestos that may have become attached to the personal protective equipment (PPE) that was used by the personnel during the railcar asbestos removal process. Also, located within asbestos removal area 202 is a conventional vacuum hose 206 that can be used by the personnel to remove any remaining finer particles of contaminated materials such as fine asbestos particles located on the PPE.

Regarding dirty change area 208, in one embodiment, located between asbestos removal area 202 and dirty change area 208 are a series of overlapping curtains 210. Preferably, overlapping curtains 210 are constructed of any suitable, durable, polymeric material. It is to be understood that overlapping curtains 210 should be sized and shaped so that airborne contaminants cannot escape from one area and enter into another area. As shown in FIG. 5, dirty change area 208 also includes a clothing receptacle 212 for use in collecting and disposing of PPE that was used during the railcar asbestos removal process. It is to be understood that the personnel should first utilize asbestos removal area 202 and then enter into the dirty change area 208 through the overlapping curtains 210. Finally, an operational shower system 211 can be added to the dirty change area 208 in order to allow the user to shower after removing the used PPE.

With respect to clean change area 216, in one embodiment, located between dirty change area 208 and clean change area 216 are a series of overlapping curtains 214. Preferably, overlapping curtains 214 are constructed of any suitable, durable, polymeric material. It is to be understood that overlapping curtains 214 should be sized and shaped so that air borne contaminants cannot escape from one area and enter into another area. It is to be further understood that after the personnel utilize dirty change area 208, the personnel can then enter into the clean change area 216 through the overlapping curtains 214. It is to be understood that in clean change area 216, the user can change into his/her regular/street clothes.

With respect to ground fault interrupters (GFIs) 62, GFIs 62 can be used to prevent electrocution, electric shocks, and burns. If a person experiences a shock, the GFI senses this and instantly cuts off power before the person can get injured. Since water is an electric conductor, GFIs 62 are used in areas where water and electricity can accidentally come into contact with each other. As shown in FIG. 4, GFIs 62 are located near the sump pump 64 and inside of the HEPA filter assembly 250. These are areas where water may have an opportunity to come into contact with electricity.

With respect to sump pump 64, sump pump 64 is a conventional sump pump that is located near the asbestos removal containment area 61 and the HEPA filter assembly 250. In one embodiment, sump pump 64 is used to collect and remove any water and media that have drained off of the railcar 100 while the railcar 100 is being subjected to the pressurized removal of the asbestos located within the railcar 100. It is to be understood that a conventional floor cleaning machine (not shown) can be used to move any mixtures of water and contaminated materials towards the sump pump 64.

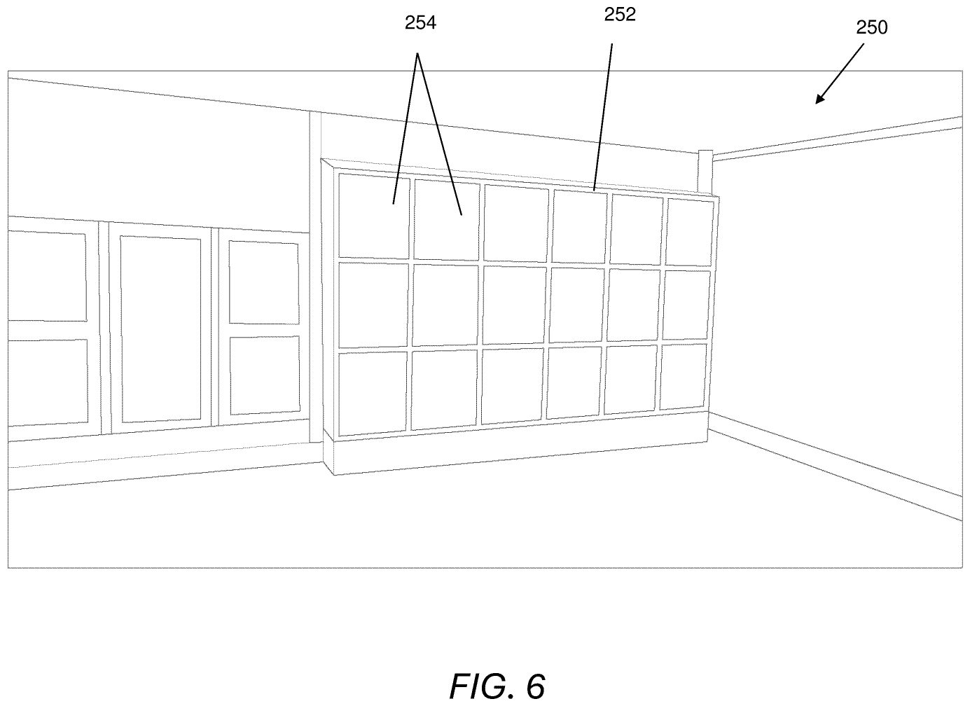

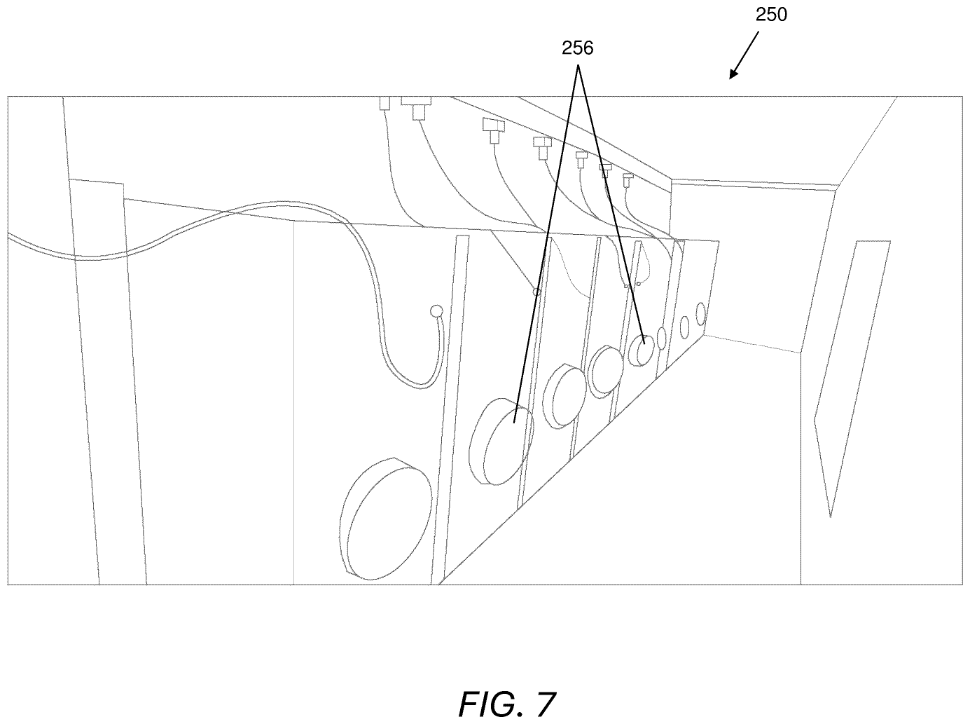

With respect to HEPA filter assembly 250, as shown in FIGS. 6 and 7, in one embodiment, HEPA filter assembly 250 includes, in part, filter frame 252, a plurality of high efficiency particulate air (HEPA) filters 254, and fans 256. Preferably, there are ten (10) fans 256 wherein each fan 256 is capable of being operated at a capacity of 5,000 cubic feet per minute (Cfm), and two additional units with a capacity of 24,000 Cfm. The air is filtered through HEPA filters 254 and then drawn out through fans 256. As discussed above, the airborne asbestos particles that are released into the air within the inner containment enclosure are captured in the HEPA filters 254.

Preferably, each HEPA filter 254 includes a primary filter, a secondary filter, and a main filter. Preferably, the HEPA filters 254 are changed daily, with the primary and secondary filters being replaced daily and the main filter cleaned daily. The pore sizes of the HEPA filters 254 range from 0.3 to 23 microns. It is to be understood that each of the plurality of fans 256 is located adjacent to one of the plurality of the HEPA filters 254.

Another unique aspect of the present invention is that the HEPA filter assembly 250 can be located within sealed containers such as metallic sea containers instead of a collapsible air lock assembly, as discussed earlier. For example, during winter months, the sealed container can be used to contain the system 2 and provide a heat source (not shown) in order to avoid freezing in cold climates. Furthermore, heated hoses and tanks can be used to recycle the water and settling and filtering of the spent water used. In this manner, the HEPA filter assembly 250 can be easily transported, set up, replaced, or maintained. It is to be understood that the HEPA filter assembly 250 is used to provide the necessary negative pressure (vacuum) of around −0.01-03″/H₂O water column within the interior of the inner containment structure 50. As shown in FIG. 4, the HEPA filter assembly 250 is used to provide an airflow through the inner containment enclosure 50 in the direction of arrow X.

### Using Contaminant Removal System 2

During the use of system 2 for removing contaminated materials such as asbestos from railcars 100 (i.e., train cars and subway cars) for subsequent recycling of the railcars, attention is directed to FIGS. 1-7. In particular, collapsible inner containment structure 50 having a HEPA filter assembly 250 that creates a negative air flow along the direction of arrow X (FIG. 4) within the inner containment structure 50 is used. Below is a summary of the procedure used to remove contaminants from a railcar 100 (FIG. 3):
1. An inner, roll-up door 52 on the inner containment structure 50 is opened at one end of the inner containment structure 50 and a railcar 100 is transported by the fork lift 150 to a work area (asbestos removal containment area 61) located within the inner containment structure 50.
2. The inner, roll-up door 52 is then closed so that the inner containment structure 50 can maintain the negative pressure within the inner containment structure 50.
3. The contaminated materials such as asbestos are removed from the inside of the railcar 100 using a mixture of pressurized water and media from the media/water delivery assembly 66.
4. Collecting any used mixture of water and media and contaminated materials through the use of the sump pump 64.
5. The inside of the railcar 100 is inspected to determine if all of the asbestos 104 has been removed from the inside of the railcar 100.
6. A final wash of the railcar 100 is completed n order to clean the railcar.
7. Finally, the inner, roll-up door 52 is opened and the cleaned railcar 100 is sent off for subsequent recycling.

With respect to using the system 2, there are several unique aspects of this method.
1. Two (2) railcars 100 are usually cleaned at a time. This results in an average of 1000 sf of asbestos material or 500 sf/car blasting which takes a total of 6 hrs/car/3 workers
2. Cleanup of a railcar 100 takes around 3 hours when using 3 workers
3. Setup and removal of railcars 100 from containment takes around 3 hrs.
4. Compressors from blast machines use 4 gal/hr of fuel (1 compressor per blast machine at 375 cfm). The compressor pressures have been optimized for the biosoluable superoxalloy abrasive blasting media with water for the increased removal rate of the surface material. Preferably, the blast pressure range is 80-120 kPA and the supply air pressure range is between 160 and 200 kPA.
5. Each blast machine is filled with 10 bags of media. Each machine is filled two (2) times to finish around 1000 sqft or 2 cars at a time.
6. The media is a superoxalloy abrasive having low dust and biosolubility characteristics. In one embodiment, the media is a biosoluble superoxalloy. This media allows for use of less blasting media, less dust, less water and it also increases the surface material removal rate.
7. 100% of the water used in the method is recycled and re-used. In particular, there is no discharge of water, media, and removed contaminated materials from the process due to the use of the sump pump 64 and a sloped floor on the asbestos removal containment area 61. The water, media, and removed contaminated materials are then pumped to settling tanks and filtered down through the use of 5 micron filters so that the water can reused through the system 2.
8. All removed contaminated materials such as asbestos and spent media are collected, double bagged and disposed of properly in an EPA approved landfill.

While it has not been mentioned, one familiar with the art would realize that the device is not limited by the materials used to create each apparatus that comprises the invention. Any other material type can comprise some or all of the elements in constructing a system for removing contaminated materials from railcars for subsequent recycling of the railcars in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A system for removing contaminated materials from railcars for subsequent recycling of the railcars, comprising:
an outer containment structure; and
an inner containment enclosure located within the outer containment structure, wherein the inner containment structure further comprises;
a front, roll-up door located at one end of the inner containment structure,
an asbestos removal containment area located adjacent to the front, roll-up door,
a decontamination enclosure located adjacent to the front, roll-up door,
a media/water delivery assembly, wherein the media/water delivery assembly is configured to be located adjacent to a railcar located within the inner containment structure, and wherein the media/water delivery assembly is configured to be used to remove contaminated materials from the railcar;
a sump pump located adjacent to the asbestos removal containment area and the media/water delivery assembly, and
a HEPA filter assembly located at another end of the inner containment structure, wherein the HEPA filter assembly is configured to be able to create a negative pressure within the inner containment structure.

2. The system, according to claim 1, wherein the outer containment structure is further comprised of:
a first frame;
a covering located over the first frame; and
an opening located at one end of the first frame.

3. The system, according to claim 1, wherein the inner containment enclosure is further comprised of:
a second frame, wherein the second frame is configured to include the front, roll-up door;
a plurality of outer walls located on sides of the second frame;
a roof located on top of the second frame; and
a rear door located across from the front, roll-up door.

4. The system, according to claim 1, wherein the decontamination enclosure is further comprised of:
an asbestos removal area, wherein the asbestos removal area is configured to be able to be used to collect and dispose of pieces of contaminate materials;
a dirty change area located adjacent to the asbestos removal area, wherein the dirty change is configured to be used for collecting and disposing of personnel protective equipment (PPE) that was used during the removal of contaminated materials from railcar; and
a clean change area located adjacent to the dirty change area, wherein the clean change area is configured to allow a user to change into other clothes of the user.

5. The system, according to claim 1, wherein the media/water delivery assembly is further comprised of:
a media and water mixing/spraying assembly, wherein the media and water mixing/spraying assembly is configured to be able to deliver a mixture of a media and water onto the railcar in order to remove the contaminated material from the railcar;
a compressor operatively connected to the media and water mixing/spraying assembly;
a media supply operatively connected to the media and water mixing/spraying assembly; and
a water supply operatively connected to the media and water mixing/spraying assembly.

6. The system, according to claim 1, wherein the HEPA filter assembly is further comprised of:
a filter frame;
a plurality of high efficiency particulate air (HEPA) filters retained within the filter frame; and
a plurality of fans, wherein each of the plurality of fans is located adjacent to one of the plurality of the HEPA filters.

7. The system, according to claim 1, wherein the system is further comprised of:
a plurality of ground fault interrupters (GFIs), wherein one of the plurality of GFIs is operatively connected to the decontamination enclosure, and another of the plurality of GFIs is operatively connected to the HEPA filter assembly.

8. A method of constructing a system for removing contaminated materials from railcars for subsequent recycling of the railcars, comprising:
providing an outer containment structure; and
providing an inner containment enclosure located within the outer containment structure, wherein the inner containment structure further comprises;
a front, roll-up door located at one end of the inner containment structure,
an asbestos removal containment area located adjacent to the front, roll-up door,
a decontamination enclosure located adjacent to the front, roll-up door,
a media/water delivery assembly, wherein the media/water delivery assembly is configured to be located adjacent to a railcar located within the inner containment structure, and wherein the media/water delivery assembly is configured to be used to remove contaminated materials from the railcar;
a sump pump located adjacent to the asbestos removal containment area and the media/water delivery assembly, and
a HEPA filter assembly located at another end of the inner containment structure, wherein the HEPA filter assembly is configured to be able to create a negative pressure within the inner containment structure.

9. The method, according to claim 8, wherein the outer containment structure is further comprised of:
a first frame;
a covering located over the first frame; and
an opening located at one end of the first frame.

10. The method, according to claim 8, wherein the inner containment enclosure is further comprised of:
a second frame, wherein the second frame is configured to include the front, roll-up door;
a plurality of outer walls located on sides of the second frame;
a roof located on top of the second frame; and
a rear door located across from the front, roll-up door.

11. The method, according to claim 8, wherein the decontamination enclosure is further comprised of:
an asbestos removal area, wherein the asbestos removal area is configured to be able to be used to collect and dispose of pieces of asbestos;
a dirty change area located adjacent to the asbestos removal area, wherein the dirty change is configured to be used for collecting and disposing of personnel protective equipment (PPE) that was used during the removal of contaminated materials from railcar; and
a clean change area located adjacent to the dirty change area, wherein the clean change area is configured to allow a user to change into other clothes of the user.

12. The method, according to claim 8, wherein the media/water delivery assembly is further comprised of:
a media and water mixing/spraying assembly, wherein the media and water mixing/spraying assembly is configured to be able to deliver a mixture of a media and water onto the railcar in order to remove the contaminated material from the railcar;
a compressor operatively connected to the media and water mixing/spraying assembly;
a media supply operatively connected to the media and water mixing/spraying assembly; and
a water supply operatively connected to the media and water mixing/spraying assembly.

13. The method, according to claim 8, wherein the HEPA filter assembly is further comprised of:
a filter frame;
a plurality of high efficiency particulate air (HEPA) filters retained within the filter frame; and
a plurality of fans, wherein each of the plurality of fans is located adjacent to one of the plurality of the HEPA filters.

14. The method, according to claim 8, wherein the method is further comprised of:
providing a plurality of ground fault interrupters (GFIs), wherein one of the plurality of GFIs is operatively connected to the decontamination enclosure, and another of the plurality of GFIs is operatively connected to the HEPA filter assembly.

15. A method of using a system for removing contaminated materials from railcars for subsequent recycling of the railcars, comprising:
providing an outer containment structure;
providing an inner containment enclosure located within the outer containment structure, wherein the inner containment structure further comprises;
a front, roll-up door located at one end of the inner containment structure,
an asbestos removal containment area located adjacent to the front, roll-up door,
a decontamination enclosure located adjacent to the front, roll-up door,
a media/water delivery assembly, wherein the media/water delivery assembly is configured to be located adjacent to a railcar located within the inner containment structure, and wherein the media/water delivery assembly is configured to be used to remove contaminated materials from the railcar;
a sump pump located adjacent to the asbestos removal containment area and the media/water delivery assembly, and
a HEPA filter assembly located at another end of the inner containment structure, wherein the HEPA filter assembly is configured to be able to create a negative pressure within the inner containment structure; and
operating the HEPA filter assembly to create a negative pressure with the inner containment enclosure;
locating the railcar within the inner containment enclosure;
utilizing the media/water delivery assembly in order to remove the contaminated materials from the railcar;
utilizing the sump pump to collect any used media, water and contaminated materials;
utilizing the HEPA filter assembly to remove airborne particles of contaminated material within the inner containment enclosure;
inspecting an inside of the railcar to determine if all of the contaminated material has been removed from the inside of the railcar;
completing a final wash of the railcar to clean the railcar; and
removing the cleaned railcar from the inner containment structure.

16. The method, according to claim 15, wherein the outer containment structure is further comprised of:
a first frame;
a covering located over the first frame; and
an opening located at one end of the first frame.

17. The method, according to claim 15, wherein the inner containment enclosure is further comprised of:
a second frame, wherein the second frame is configured to include the front, roll-up door;
a plurality of outer walls located on sides of the second frame;
a roof located on top of the second frame; and
a rear door located across from the front, roll-up door.

18. The method, according to claim 15, wherein the decontamination enclosure is further comprised of:
an asbestos removal area, wherein the asbestos removal area is configured to be able to be used to collect and dispose of pieces of asbestos;
a dirty change area located adjacent to the asbestos removal area, wherein the dirty change is configured to be used for collecting and disposing of personnel protective equipment (PPE) that was used during the removal of contaminated materials from railcar; and
a clean change area located adjacent to the dirty change area, wherein the clean change area is configured to allow a user to change into other clothes of the user.

19. The method, according to claim 8, wherein the media/water delivery assembly is further comprised of:
a media and water mixing/spraying assembly, wherein the media and water mixing/spraying assembly is configured to be able to deliver a mixture of a media and water onto the railcar in order to remove the contaminated material from the railcar;
a compressor operatively connected to the media and water mixing/spraying assembly;
a media supply operatively connected to the media and water mixing/spraying assembly; and
a water supply operatively connected to the media and water mixing/spraying assembly.

20. The method, according to claim 8, wherein the HEPA filter assembly is further comprised of:
a filter frame;
a plurality of high efficiency particulate air (HEPA) filters retained within the filter frame; and
a plurality of fans, wherein each of the plurality of fans is located adjacent to one of the plurality of the HEPA filters.
